(19) United States
(12) Patent Application Publication
(10) Pub. No.: US 2026/0280828 A1
(43) Pub. Date: Sep. 17, 2026

(54) METHOD AND APPARATUS FOR DETERMINING HARQ-ACK CODEBOOK IN MOBILE COMMUNICATIONS

(71) Applicant: MEDIATEK INC., Hsinchu City (TW)

(72) Inventors: Yi-Ju LIAO, Hsinchu City (TW); Pei-Kai LIAO, Hsinchu City (TW); Chi-Hsuan HSIEH, Hsinchu City (TW)

(73) Assignee: MEDIATEK INC., Hsinchu City (TW)

(21) Appl. No.: 19/473,794

(22) PCT Filed: Oct. 24, 2024
(86) PCT No.: PCT/CN2024/126929

§ 371 Date: Oct. 8, 2025

Related U.S. Application Data
(60) Provisional application No. 63/594,449, filed on Oct. 31, 2023.

(51) Int. Cl. H04L 5/00

(52) U.S. Cl. CPC H04L 5/0094; H04L 5/0044; H04L 5/0055

(57) ABSTRACT

Various solutions for determining a hybrid automatic repeat request-acknowledgment (HARQ-ACK) codebook with respect to an apparatus in mobile communications are described. The apparatus may receive a downlink control information (DCI). The DCI may include a physical downlink control channel (PDCCH) parameter indicating a count of one or more transmitted PDCCHs and a physical downlink shared channel (PDSCH) parameter indicating a count of one or more allocated PDSCHs. The apparatus may determine a HARQ-ACK codebook corresponding to the one or more allocated PDSCHs according to the PDCCH parameter and the PDSCH parameter. The apparatus may transmit the HARQ-ACK codebook.

### CROSS REFERENCE TO RELATED PATENT APPLICATION(S)

The present disclosure is part of a non-provisional application claiming the priority benefit of U.S. Patent Application No. 63/594,449, filed 31 Oct. 2023, the content of which herein being incorporated by reference in its entirety.

### TECHNICAL FIELD

The present disclosure is generally related to mobile communications and, more particularly, to determining a hybrid automatic repeat request-acknowledgment (HARQ-ACK) codebook with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, hybrid automatic repeat request-acknowledgment (HARQ-ACK) codebook is introduced for reliability of data transmission. In particular, the HARQ-ACK codebook may be transmitted by a user equipment (UE) to a base station (BS) to indicate whether the downlink (DL) transmissions (e.g., physical downlink shared channel (PDSCH)) was successfully decoded. More specifically, the HARQ-ACK codebook may be a structured set of bits that carries feedback information about the reception status of DL transmissions, which may help ensure reliable data transmission by allowing the UE to request retransmissions of incorrectly received packets. The HARQ-ACK codebook may be used to report ACK (acknowledgment) or NACK (negative acknowledgment) for multiple data transmissions that have been received over a specific period. However, in some newly developed network scenarios (e.g., one serving cell consisting of multiple carriers, multi-carrier downlink control information (MC-DCI), etc.), the use of the legacy HARQ-ACK codebook may not be efficient or flexible enough.

Accordingly, how to improve the use of the HARQ-ACK codebook becomes an important issue in the newly developed wireless communication network. Therefore, there is a need to provide proper schemes to improve the use of the HARQ-ACK codebook.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to determining a hybrid automatic repeat request-acknowledgment (HARQ-ACK) codebook with respect to apparatus in mobile communications.

In one aspect, a method may involve an apparatus receiving a downlink control information (DCI). The DCI may include a physical downlink control channel (PDCCH) parameter indicating a count of one or more transmitted PDCCHs and a physical downlink shared channel (PDSCH) parameter indicating a count of one or more allocated PDSCHs. The method may further involve the apparatus determining a HARQ-ACK codebook corresponding to the one or more allocated PDSCHs according to the PDCCH parameter and the PDSCH parameter. The method may further involve the apparatus transmitting the HARQ-ACK codebook.

In one aspect, a method may involve an apparatus transmitting a DCI. The DCI may include a PDCCH parameter indicating a count of one or more transmitted PDCCHs and a PDSCH parameter indicating a count of one or more allocated PDSCHs. The PDCCH parameter and the PDSCH parameter may be for determining a HARQ-ACK codebook corresponding to the one or more allocated PDSCHs. The method may further involve the apparatus receiving the HARQ-ACK codebook.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, by the transceiver, a DCI. The DCI may include a PDCCH parameter indicating a count of one or more transmitted PDCCHs and a PDSCH parameter indicating a count of one or more allocated PDSCHs. The processor may further perform operations comprising determining a HARQ-ACK codebook corresponding to the one or more allocated PDSCHs according to the PDCCH parameter and the PDSCH parameter. The processor may further perform operations comprising transmitting, via the transceiver, the HARQ-ACK codebook.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to determining a hybrid automatic repeat request-acknowledgment (HARQ-ACK) codebook with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may transmit a downlink control information (DCI) to a user equipment (UE). The DCI may include a physical downlink control channel (PDCCH) parameter and a physical downlink shared channel (PDSCH) parameter. The PDCCH parameter may indicate a count of PDCCH(s) transmitted from the network node to the UE. The PDSCH parameter may indicate a count of PDSCH(s) allocated to the UE. Based on receiving the DCI, the UE may determine a HARQ-ACK codebook corresponding to the allocated PDSCH(s) according to the PDCCH parameter and the PDSCH parameter. The UE may then transmit the HARQ-ACK codebook to the network node.

In summary, because the UE may obtain the information of the current counts of transmitted PDCCH(s) and allocated PDSCH(s) from the network node based on the PDCCH parameter and PDSCH parameter of the DCI, the UE may determine if there is any missed PDCCH(s) or missed PDSCH(s) based on DCI transmissions. Accordingly, the UE may then determine the HARQ-ACK codebook based on the missed PDCCH(s) and the missed PDSCH(s) and transmit the HARQ-ACK codebook to the network node.

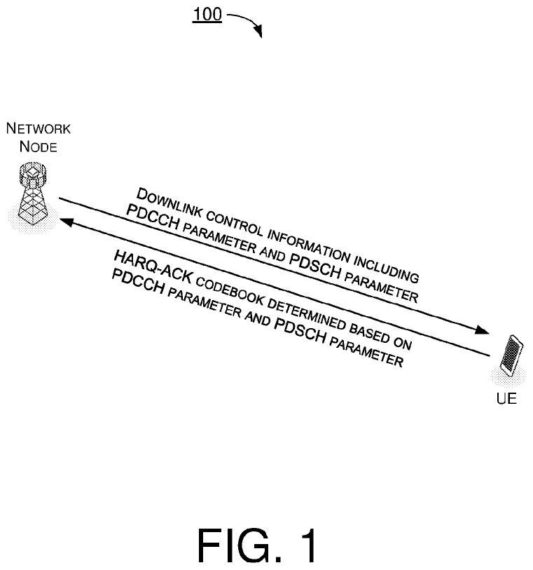

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may transmit a DCI to the UE. The DCI may include a PDCCH parameter and a PDSCH parameter. The PDCCH parameter may be associated with the number of PDCCH(s) that have been transmitted from the network node to the UE. In other words, the PDCCH parameter may indicate a count of one or more transmitted PDCCHs. The PDSCH parameter may be associated with the number of PDSCH(s) that have been allocated to the UE. In other words, the PDSCH parameter may indicate a count of one or more allocated PDSCHs. After receiving the DCI, the UE may determine a HARQ-ACK codebook corresponding to the one or more allocated PDSCHs according to the PDCCH parameter and the PDSCH parameter. The UE may the transmit the HARQ-ACK codebook to the network node.

Accordingly, because the UE may obtain: (1) based on the PDCCH parameter, the information of the current count of PDCCH(s) that have been transmitted from the network node; and (2) based on the PDSCH parameter, the information of the current count of PDSCH(s) that have been allocated to the UE, the UE may determine if there is any missed PDCCH(s) or missed PDSCH(s) by following the trail of the DCI transmissions.

In some implementations, the UE may determine if there is any missed PDCCH(s) by comparing the count of the one or more transmitted PDCCHs with a count of one or more informed PDCCHs and determine if there is any missed PDSCH(s) by comparing the count of the one or more allocated PDSCHs with a count of one or more informed PDSCHs.

In particular, the count of the one or more informed PDCCHs and the count of the one or more informed PDSCHs may be obtained from a previous DCI. More specifically, the network node may transmit another DCI (hereinafter referred to as the previous DCI) at a timing ‘T1’ before the DCI transmitted at a timing ‘T2’. The previous DCI may include: (1) a PDCCH parameter indicating a count of one or more transmitted PDCCHs before and including ‘T1’; and (2) a PDSCH parameter indicating a count of one or more allocated PDSCHs indicated in DCIs transmitted before and including ‘T1’. Then, the UE may: (1) record the count of one or more transmitted PDCCHs as the count of the one or more informed PDCCHs; and (2) record the count one or more allocated PDSCHs as the count of the one or more informed PDSCHs.

Accordingly, the UE may determine if there is any missed PDCCH(s) by subtracting the count of the one or more informed PDCCHs from the count of one or more transmitted PDCCHs. In an event that the result is 1, it means that there is not any missed PDCCH. In an event that the result is ‘x’ greater than 1, it means that there is (are) ‘x−1’ missed PDCCH(s). In an event that the result is 0, it means that there are (i×2^{N}−1) missed PDCCH(s), where N is the bitwidth used to indicate the count of the transmitted PDCCH, and i is a positive integer. Further, the UE may determine if there is any missed PDSCH(s) by subtracting the count of the one or more informed PDSCHs from the count of one or more allocated PDSCHs. In an event that the result is ‘a’ (which represents the number of PDSCH(s) indicated by the current received DCI), it means that there is not any missed PDSCH. In an event the result is ‘y’ greater than ‘a’, it means that there is (are) ‘y−a’ missed PDSCH(s). In an event the result is 0, it means that there are (j×2^{M}−a) missed PDSCH(s), where M is the bitwidth used to indicate the count of the transmitted PDSCH, and j is a positive integer.

In some implementations, the DCI may include a single DCI or a two-stage DCI scheduling at least one PDSCH over the same carrier associated with one serving cell. For example, the DCI schedules 2 PDSCHs over the same carrier associated with one serving cell. In some implementations, the DCI may include a single DCI or a two-stage DCI scheduling at least one PDSCH across multiple carriers associated with one serving cell. For example, the DCI schedules 2 PDSCHs over 4 carriers associated with one serving cell, with at least one PDSCH spanning across 2 carriers. In some implementations, the DCI may include a single DCI or a two-stage DCI scheduling at least one PDSCH over across one or more slots.

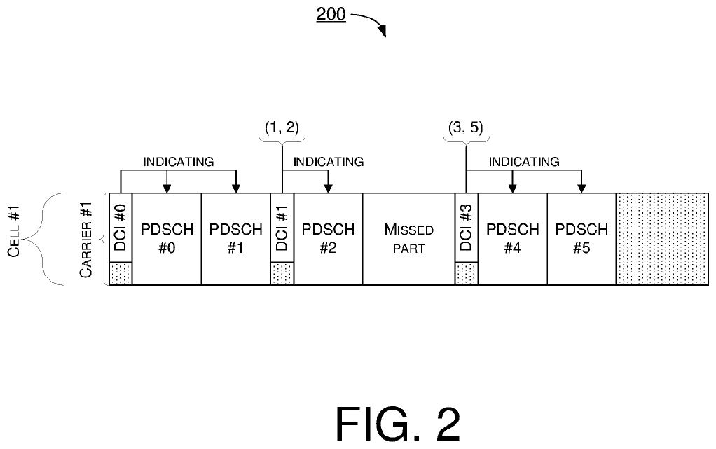

FIG. 2 illustrates an example scenario 200 under schemes in accordance with implementations of the present disclosure. For example, the UE receives a DCI #1 associated with carrier #1 of cell #1 while the DCI #1 includes a pair of parameters (1, 2) which are a PDCCH parameter ‘1’ and a PDSCH parameter ‘2’. The PDCCH parameter ‘1’ indicates two transmitted PDCCHs (i.e., two transmitted DCIs #0 and #1), and the PDSCH parameter ‘2’ indicates three allocated PDSCHs by the transmitted DCIs. More specifically, the PDCCH parameter ‘1’ means the count from 0 to 1, which is 2 (transmitted DCIs), and the PDSCH parameter ‘2’ means the count from 0 to 2, which is 3 (allocated PDSCHs). The UE records two PDCCHs as the count of the informed PDCCHs, and records three PDSCHs as the count of the informed PDSCHs.

Then, the UE receives a DCI #3 associated with carrier #1 of cell #1 while the DCI #3 includes a pair of parameters (3, 5) which are a PDCCH parameter ‘3’ and a PDSCH parameter ‘5’. The PDCCH parameter ‘3’ indicates four transmitted PDCCHs (i.e., four transmitted DCIs), and the PDSCH parameter ‘5’ indicates six allocated PDSCHs by the transmitted DCIs. The DCI #3 indicates two PDSCHs. Regarding PDCCH, the UE subtracts 2 from 4, resulting in 2, which means that there is (2−1)=1 missed PDCCH. Regarding PDSCH, the UE subtracts 3 from 6, resulting in 3, which means that there is (3−2)=1 missed PDSCH.

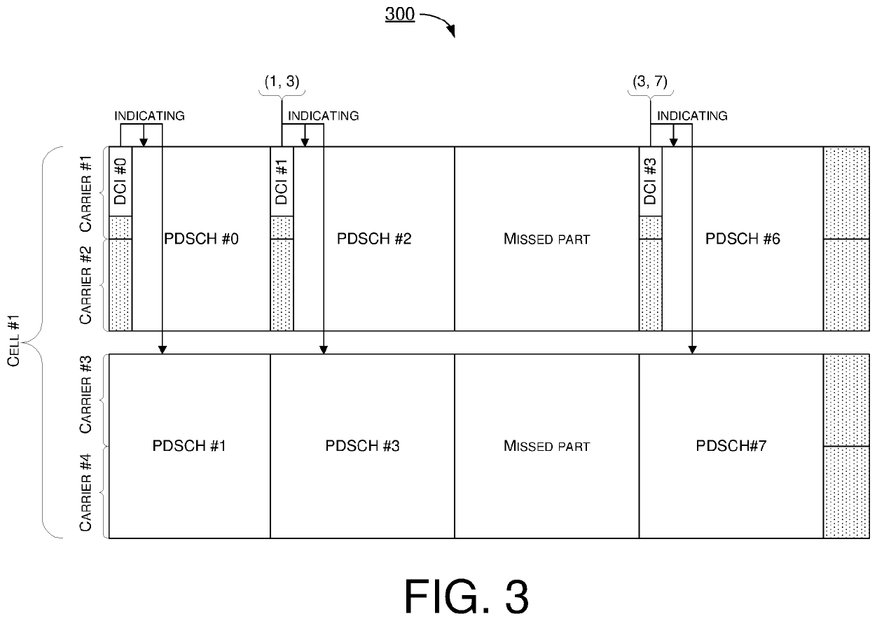

FIG. 3 illustrates an example scenario 300 under schemes in accordance with implementations of the present disclosure. For example, the UE receives a DCI #1 associated with carrier #1 of cell #1 while the DCI #1 includes a pair of parameters (1, 3) which are a PDCCH parameter ‘1’ and a PDSCH parameter ‘3’. The PDCCH parameter ‘l’ indicates two transmitted PDCCHs (i.e., two transmitted DCIs #0 and #1), and the PDSCH parameter ‘3’ indicates four allocated PDSCHs by the two transmitted DCIs #0 and #1. More specifically, the PDCCH parameter ‘1’ means the count from 0 to 1, which is 2 (transmitted DCIs), and the PDSCH parameter ‘3’ means the count from 0 to 3, which is 4 (allocated PDSCHs). The UE records two PDCCHs as the count of the informed PDCCHs, and records four PDSCHs as the count of the informed PDSCHs.

Then, the UE receives a DCI #3 associated with carrier #1 of cell #1 while the DCI #3 includes a pair of parameters (3, 7) which are a PDCCH parameter ‘3’ and a PDSCH parameter ‘7’. The PDCCH parameter ‘3’ indicates four transmitted PDCCHs (i.e., four transmitted DCIs), and the PDSCH parameter ‘7’ indicates eight allocated PDSCHs by the transmitted DCIs. The DCI #3 indicates two PDSCHs. Regarding PDCCH, the UE subtracts 2 from 4, resulting in 2, which means that there is (2−1)=1 missed PDCCH. Regarding PDSCH, the UE subtracts 4 from 8, resulting in 4, which means that there is (4−2)=2 missed PDSCHs.

In some implementations, when DCIs schedule PDSCHs having the same frequency (e.g., same starting carrier index or bandwidth part (BWP) cluster index), bits of the HARQ-ACK codebook may be placed in an ascending order based on the starting times of PDCCH monitoring occasions. In particular, there may be the DCI scheduling a first PDSCH and a previous DCI scheduling a second PDSCH (i.e., the second PDSCH may be after the first PDSCH with respect to time domain), and the first PDSCH and the second PDSCH may be associated with the same carrier index. The HARQ-ACK codebook may include a first HARQ-ACK corresponding to the first PDSCH and a second HARQ-ACK corresponding to the second PDSCH. In the HARQ-ACK codebook, the first HARQ-ACK may be prior to the second HARQ-ACK.

In some implementations, when the DCI schedules multiple PDSCHs having different frequency (e.g., PDSCHs corresponding to different starting carrier index or BWP cluster index), bits of the HARQ-ACK codebook may be placed in an order based on the starting (or smallest) carrier indexes or BWP cluster indexes of PDSCHs. In particular, the DCI may schedule a first PDSCH associated with a first carrier index and a second PDSCH associated with a second carrier index. The HARQ-ACK codebook may include a first HARQ-ACK corresponding to the first PDSCH and a second HARQ-ACK corresponding to the second PDSCH. In the HARQ-ACK codebook, the first HARQ-ACK may be prior to the second HARQ-ACK in an event that the first carrier index is smaller than the second carrier index.

In some implementations, when the DCI schedules multiple PDSCHs having the same frequency (e.g., PDSCHs corresponding to same starting carrier index or BWP cluster index), bits of the HARQ-ACK codebook may be placed in an ascending order according to the starting times of PDSCHs. In particular, the DCI may schedule a first PDSCH and a second PDSCH. Both the first PDSCH and the second PDSCH may be associated with the same carrier index. The HARQ-ACK codebook may include a first HARQ-ACK corresponding to the first PDSCH and a second HARQ-ACK corresponding to the second PDSCH. In the HARQ-ACK codebook, the first HARQ-ACK may be prior to the second HARQ-ACK in an event that the second PDSCH is after the first PDSCH with respect to time domain.

Taking the scenario 200 as an example, PDSCHs are associated with the same carrier which has carrier index #1. Assuming the UE: (1) successfully decodes PDSCHs #0, #1, #2, #4, and #5; and (2) misses PDSCH #3 (not shown in FIG. 2), the order of HARQ-ACKs in the HARQ-ACK codebook, according to the mentioned rules, is determined as (1, 1, 1, 0, 1, 1), where ‘l’ represents ACK and ‘0’ represents NACK.

Taking the scenario 300 as an example, PDSCH #0 and #1, scheduled by DCI #0, are associated with different carriers, with carrier indexes #1 and #3. PDSCH #0 spans carriers #1 and #2. PDSCH #1 spans carriers #3 and #4. PDSCH #2 and #3, scheduled by DCI #1, are associated with different carriers, with carrier indexes #1 and #3. PDSCH #2 spans carriers #1 and #2. PDSCH #3 spans carriers #3 and #4. PDSCH #6 and #7, scheduled by DCI #3, are associated with different carriers, with carrier indexes #1 and #3. PDSCH #6 spans carriers #1 and #2. PDSCH #7 spans carriers #3 and #4.

Assuming the UE: (1) successfully decodes PDSCHs #0, #1, #2, #6 and #7; (2) fails to decode PDSCH #3; and (3) misses PDSCH #4 and #5 (not shown in FIG. 3), the order of HARQ-ACKs in the HARQ-ACK codebook, according to the mentioned rules, is determined as (1, 1, 1, 0, 0, 0, 1, 1), where ‘l’ represents ACK and ‘0’ represents NACK.

In some implementations, the network node may transmit an indicator indicating a size of the HARQ-ACK codebook. After receiving the indicator, the UE may transmit the HARQ-ACK codebook in the size. In some cases, when the determined HARQ-ACK codebook does not match the size, the UE may pad the HARQ-ACK codebook with ‘0’ until the HARQ-ACK codebook reaches the size. For example, the network node transmits the indicator indicating a size 8 bits of the HARQ-ACK codebook. When the UE determines the HARQ-ACK codebook to be 7 bits, represented as (1, 1, 1, 1, 1, 1, 1), the UE pads one ‘0’ to the HARQ-ACK codebook as indicated 8 bits, represented as (1, 1, 1, 1, 1, 1, 1, 0).

In some implementations, the HARQ-ACKs for the PDSCHs corresponding to same HARQ or PDSCH group may be included in the HARQ-ACK codebook. In some implementations, HARQ-ACK may be generated per code block group (CBG) when CBG is supported.

In some implementations, the HARQ-ACK codebook may be determined for one or more serving cells, and the HARQ-ACK codebook may be transmitted via an uplink (UL) resource scheduled for the one or more serving cells.

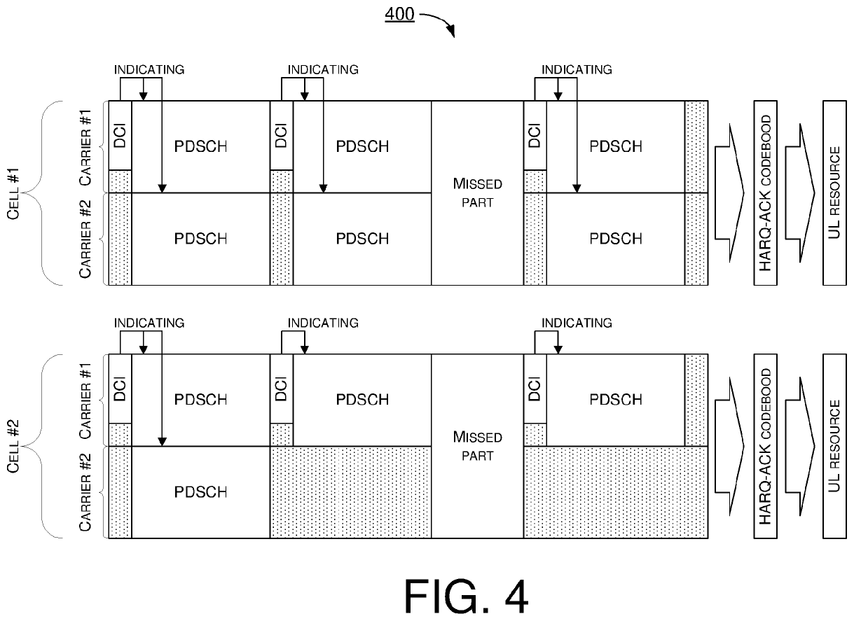

FIG. 4 illustrates an example scenario 400 under schemes in accordance with implementations of the present disclosure. In some cases, the HARQ-ACK codebook may be determined per serving cell, and the HARQ-ACK codebook may be transmitted via an UL resource scheduled per serving cell. More specifically, there may be multiple determined HARQ-ACK codebooks. Each HARQ-ACK codebook may be determined for one corresponding serving cell and be transmitted via an UL resource scheduled for the corresponding serving cell.

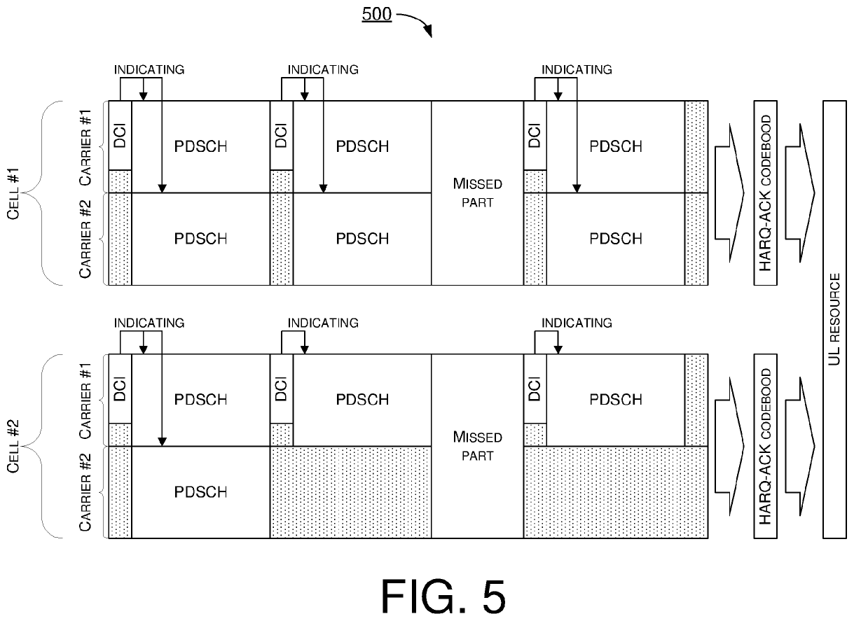

FIG. 5 illustrates an example scenario 500 under schemes in accordance with implementations of the present disclosure. In some cases, the HARQ-ACK codebook may be determined per serving cell, and the HARQ-ACK codebook may be transmitted via an UL resource scheduled for the serving cells. More specifically, there may be multiple determined HARQ-ACK codebooks. Each HARQ-ACK codebook may be determined for one corresponding serving cell. The HARQ-ACK codebooks may be transmitted via an UL resource scheduled for all the serving cells. In other words, the UL resource may include the HARQ-ACK codebooks determined for respective serving cell.

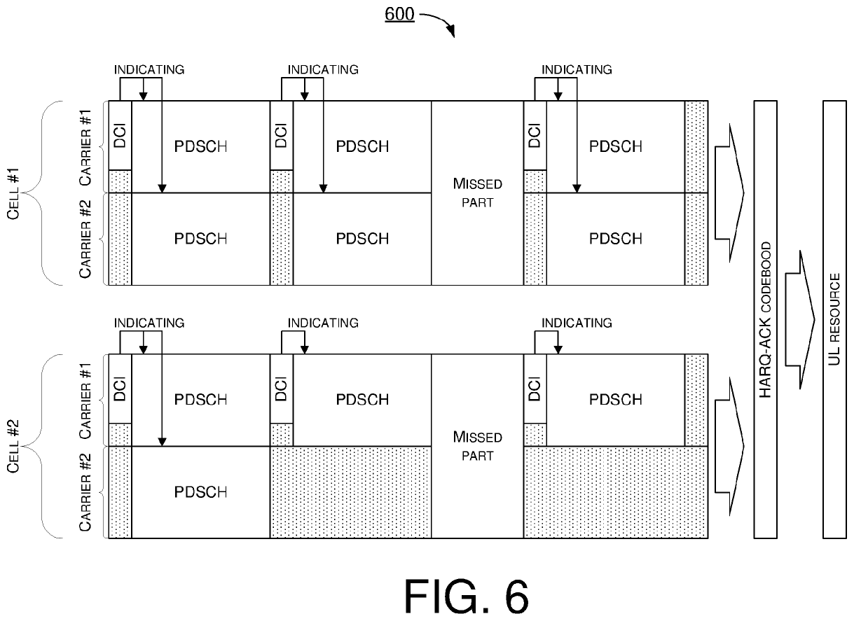

FIG. 6 illustrates an example scenario 600 under schemes in accordance with implementations of the present disclosure. In some cases, the HARQ-ACK codebook may be determined for serving cells, and the HARQ-ACK codebook may be transmitted via an UL resource scheduled for the serving cells. More specifically, there may be multiple serving cells. The UE may determine single HARQ-ACK codebook for all the serving cells and transmit the HARQ-ACK codebook via an UL resource scheduled for the serving cells.

In some implementations, the DCI of the present disclosure may include fields of: (1) the PDCCH parameter indicating a count of one or more transmitted PDCCHs, (2) the PDSCH parameter indicating a count of one or more allocated PDSCHs scheduled up to the currently received DCI or up to the current PDCCH monitoring occasion and (3) at least one of: (a) HARQ/PDSCH group index; (b) new feedback indicator; (c) new data indicator (NDI); (d) redundancy version (RV); and (e) HARQ process number. In some cases, when single stage DCI is applied, the above field(s) exists in the common part of DCI fields. In some cases, when two-stage DCI is applied, the above field(s) exists in the first stage DCI or the common part of the second stage DCI.

In some implementations, the PDCCH parameter may include N bit(s) so that maximum ‘2^{N}−1’ consecutive missed DCI(s) may be detectable. For example, the PDCCH parameter is 2 bits so that (2²−1)=3 consecutive missed DCIs can be detectable. The PDSCH parameter may include

$$⌈ {log}_{2} [ ( N + 1 ) * {M}_{P D S C H}^{MAX , DCI} ] ⌉$$

bits where

$${M}_{PDSCH}^{M AX , DCI}$$

represents maximum PDSCH(s) one DCI may be capable of scheduling.

In some embodiments, for each DCI (received or determined to be missed), the UE may generate maximum HARQ-ACK(s) and determine a HARQ-ACK codebook based on the generated HARQ-ACK(s). In particular, the network node may configure the UE a maximum number of PDSCH(s) that one DCI may schedule. Based on the configuration, the UE may determine HARQ-ACK(s) corresponding to possible maximum PDSCH(s).

More specifically, the network node may transmit a DCI to the UE. The DCI may include a PDCCH parameter associated with the number of PDCCH(s) that have been transmitted from the network node to the UE. In other words, the PDCCH parameter may indicate a count of one or more transmitted PDCCHs. Then, the UE may determine if there is any missed PDCCH(s) by comparing the count of the one or more transmitted PDCCHs with a count of one or more informed PDCCHs.

In some implementations, the count of the one or more informed PDCCHs may be obtained from a previous DCI. In particular, the network node may transmit another DCI (hereinafter referred to as the previous DCI) at a timing ‘T1’ before the DCI transmitted at a timing ‘T2’. The previous DCI may include a PDCCH parameter indicating a count of one or more transmitted PDCCHs before and including ‘T1’. Then, the UE may record the count of one or more transmitted PDCCHs as the count of the one or more informed PDCCHs.

Accordingly, the UE may determine if there is any missed PDCCH(s) by subtracting the count of the one or more informed PDCCHs from the count of one or more transmitted PDCCHs. In an event that the result is 1, it means that there is not any missed PDCCH. In an event that the result is ‘x’ greater than 1, it means that there is (are) ‘x−1’ missed PDCCH(s). In an event that the result is 0, it means that there are (i×2^{N}−1) missed PDCCH(s), where N is the bitwidth used to indicate the count of the transmitted PDCCH, and i is a positive integer. After determining the number of missed PDCCH(s), the UE may generate maximum HARQ-ACK(s) for PDSCH(s) scheduled by each DCI (i.e., by each PDCCH) and determine a HARQ-ACK codebook based on these generated HARQ-ACK(s).

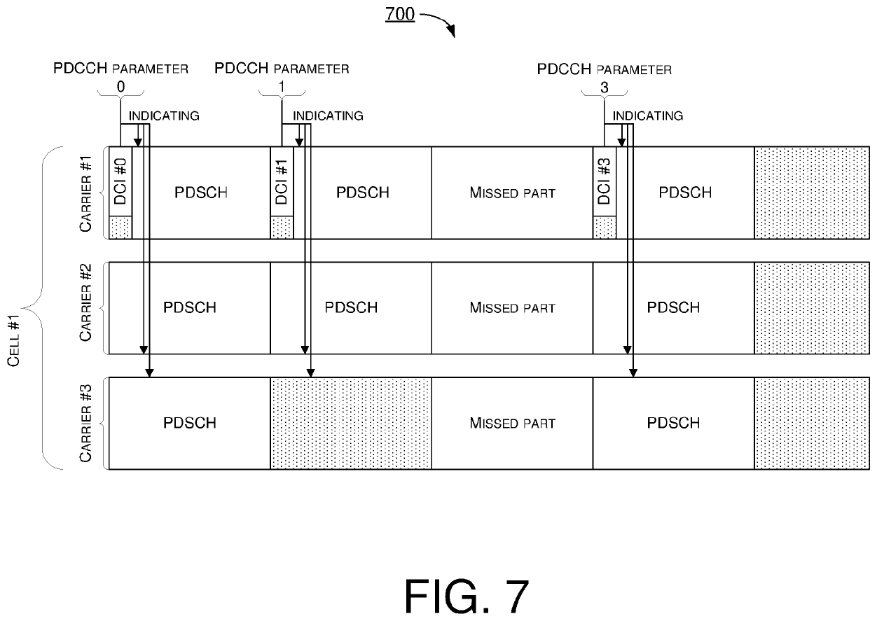

FIG. 7 illustrates an example scenario 700 under schemes in accordance with implementations of the present disclosure. For example, the network node configures the UE a maximum number 3 of PDSCHs that one DCI is capable of scheduling, where each PDSCH may be transmitted on one carrier. In other words, the UE is configured such that each DCI can schedule at most 3 PDSCHs.

Further, the UE receives a DCI #0 associated with carrier #1 of cell #1. The DCI #0 includes a PDCCH parameter ‘0’ and schedules 3 PDSCHs on carriers #1 to #3 respectively. The PDCCH parameter ‘0’ indicates one transmitted PDCCH (i.e., transmitted DCI #0). More specifically, the PDCCH parameter ‘0’ means the count from 0, which is 1 (transmitted DCI). The UE records one PDCCH as the count of the informed PDCCH. The UE generates HARQ-ACKs as 1, 1, 1 for the PDSCHs scheduled by DCI #0, while the three PDSCHs are all successfully decoded.

Then, the UE receives a DCI #1 associated with carrier #1 of cell #1. The DCI #1 includes a PDCCH parameter ‘1’ and schedules 2 PDSCHs. The PDCCH parameter ‘1’ indicates two transmitted PDCCHs (i.e., two transmitted DCI #0 and #1). More specifically, the PDCCH parameter ‘1’ means the count from 0 to 1, which is 2 (transmitted DCIs). The UE subtracts 1 from 2, resulting in 1, which means that there is (1−1)=0 missed PDCCH. The UE records two PDCCHs as the count of the informed PDCCHs. The UE generates HARQ-ACKs as 1, 1 for the PDSCHs scheduled by DCI #1, while the two PDSCHs are all successfully decoded. In addition, regarding DCI #1, the UE pads the HARQ-ACKs with a 0 as 1, 1, 0 to make the number of the HARQ-ACKs reach the maximum number 3 of PDSCHs that one DCI is capable of scheduling.

Then, the UE receives a DCI #3 associated with carrier #1 of cell #1. The DCI #1 includes a PDCCH parameter ‘3’ and schedules 3 PDSCHs. The PDCCH parameter ‘3’ indicates four transmitted PDCCHs. More specifically, the PDCCH parameter ‘3’ means the count from 0 to 3, which is 4 (transmitted DCIs). The UE subtracts 2 from 4, resulting in 2, which means that there is (2−1)=1 missed PDCCH. Regarding the one missed PDCCH (missed DCI), the UE generates HARQ-ACKs as 0, 0, 0 to make the number of the HARQ-ACKs reach the maximum number 3 of PDSCHs that one DCI is capable of scheduling. Regarding DCI #3, the UE generates HARQ-ACKs as 1, 0, 1 while 2 PDSCHs are successfully decoded and 1 PDSCH is failed to be decoded.

Accordingly, based on the generated HARQ-ACKs of the received DCIs and determined to be missed DCI, the UE determines the HARQ-ACK codebook as (1, 1, 1, 1, 1, 0, 0, 0, 0, 1, 0 1), and transmits the HARQ-ACK codebook to the network node.

### Illustrative Implementations

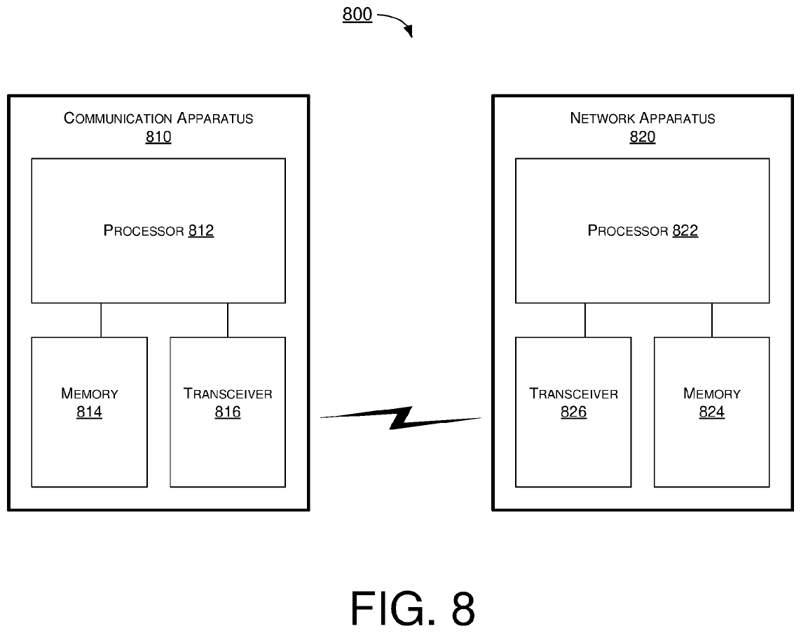

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to Determining a HARQ-ACK codebook with respect to UE and network apparatus in mobile communications, including scenarios/schemes described above as well as processes 900 and 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, a digital camera, or a computing equipment such as a tablet computer, a laptop computer or a notebook computer. Communication apparatus 810 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of a network apparatus, which may be a network node such as a satellite, a base station, a small cell, a router or a gateway. For instance, network apparatus 820 may be implemented in an eNodeB in an LTE network, in a gNB in a 5G/NR, IoT, NB-IoT or IIOT network or in a satellite or base station in a 6G network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including determining a HARQ-ACK codebook in a device (e.g., as represented by communication apparatus 810) and a network (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In other words, processor 812 may transceive the data such as configuration, message, signal, information, indicator, etc. via transceiver 816. In some implementations, communication apparatus 810 may further include a memory 814 coupled to processor 812 and capable of being accessed by processor 812 and storing data therein. In some implementations, network apparatus 820 may also include a transceiver 826 coupled to processor 822 and capable of wirelessly transmitting and receiving data. In other words, processor 822 may transceive the data such as configuration, message, signal, information, indicator, etc. via transceiver 826. In some implementations, network apparatus 820 may further include a memory 824 coupled to processor 822 and capable of being accessed by processor 822 and storing data therein. Accordingly, communication apparatus 810 and network apparatus 820 may wirelessly communicate with each other via transceiver 816 and transceiver 826, respectively. To aid better understanding, the following description of the operations, functionalities and capabilities of each of communication apparatus 810 and network apparatus 820 is provided in the context of a mobile communication environment in which communication apparatus 810 is implemented in or as a communication apparatus or a UE and network apparatus 820 is implemented in or as a network node of a communication network.

In some implementations, each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

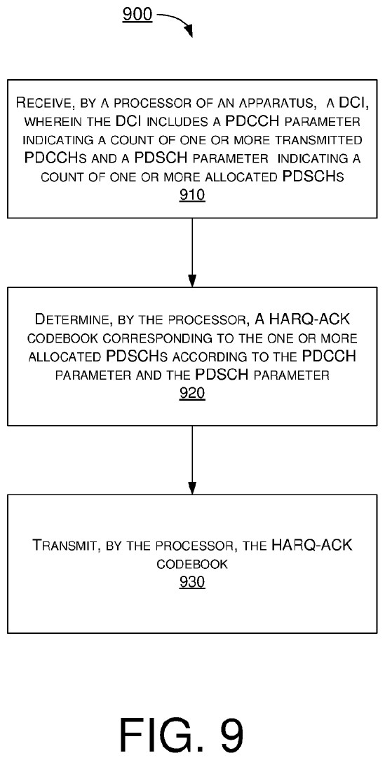

FIG. 9 illustrates an example process 900 in accordance with an implementation of the present disclosure. Process 900 may be an example implementation of above scenarios/schemes, whether partially or completely, with respect to determining a HARQ-ACK codebook of the present disclosure. Process 900 may represent an aspect of implementation of features of communication apparatus 810. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 810 or any suitable UE or machine type devices. Solely for illustrative purposes and without limitation, process 900 is described below in the context of communication apparatus 810. Process 900 may begin at block 910.

At block 910, process 900 may involve processor 812 of communication apparatus 810 receiving a DCI. The DCI may include a PDCCH parameter indicating a count of one or more transmitted PDCCHs and a PDSCH parameter indicating a count of one or more allocated PDSCHs. Process 900 may proceed from block 910 to block 920.

At block 920, process 900 may involve processor 812 of communication apparatus 810 determining a HARQ-ACK codebook corresponding to the one or more allocated PDSCHs according to the PDCCH parameter and the PDSCH parameter. Process 900 may proceed from block 920 to block 930.

At block 930, process 900 may involve processor 812 of communication apparatus 810 transmitting the HARQ-ACK codebook.

In some implementations, a MAC-CE header of the MAC PDU may be without length field.

In some implementations, process 900 involve processor 812 of communication apparatus 810 determining a number of one or more missed PDCCHs by comparing the count of the one or more transmitted PDCCHs with a count of one or more informed PDCCHs. Process 900 may involve processor 812 of communication apparatus 810 determining a number of one or more missed PDSCHs by comparing the count of the one or more allocated PDSCHs with a count of one or more informed PDSCHs. Process 900 may involve processor 812 of communication apparatus 810 determining the HARQ-ACK codebook corresponding to the one or more allocated PDSCHs based on the number of the one or more missed PDCCHs and the number of the one or more missed PDSCHs.

In some implementations, the DCI may include a single DCI or a two-stage DCI scheduling at least one PDSCH across one or more carriers or one or more slots.

In some implementations, the DCI may schedule a first PDSCH. The first PDSCH and a second PDSCH scheduled by a previous DCI may be both associated with the same carrier index. The HARQ-ACK codebook may include a first HARQ-ACK corresponding to the first PDSCH and a second HARQ-ACK corresponding to the second PDSCH. The first HARQ-ACK may be prior to the second HARQ-ACK in the HARQ-ACK codebook.

In some implementations, the DCI may schedule a first PDSCH associated with a first carrier index and a second PDSCH associated with a second carrier index. The HARQ-ACK codebook may include a first HARQ-ACK corresponding to the first PDSCH and a second HARQ-ACK corresponding to the second PDSCH. The first HARQ-ACK may be prior to the second HARQ-ACK in the HARQ-ACK codebook in an event that the first carrier index is smaller than the second carrier index.

In some implementations, the DCI may schedule a first PDSCH and a second PDSCH both associated with the same carrier index. The HARQ-ACK codebook may include a first HARQ-ACK corresponding to the first PDSCH and a second HARQ-ACK corresponding to the second PDSCH. The first HARQ-ACK may be prior to the second HARQ-ACK in the HARQ-ACK codebook in an event that the second PDSCH is after the first PDSCH with respect to time domain.

In some implementations, process 900 involve processor 812 of communication apparatus 810 receiving an indicator indicating a size of the HARQ-ACK codebook.

In some implementations, the HARQ-ACK codebook may be determined for one or more serving cells, and the HARQ-ACK codebook may be transmitted via an UL resource scheduled for the one or more serving cells.

In some implementations, the UL resource includes another HARQ-ACK codebook.

In some implementations, the DCI may include at least one field of: a HARQ or PDSCH group index; a feedback indicator; a data indicator; a redundancy version; and a HARQ process number. In an invent that the DCI includes single DCI, the at least one field may exist in a common part of DCI fields. In an event that the DCI includes two-stage DCI, the at least one field may exist in a first stage DCI or a common part of a second stage DCI.

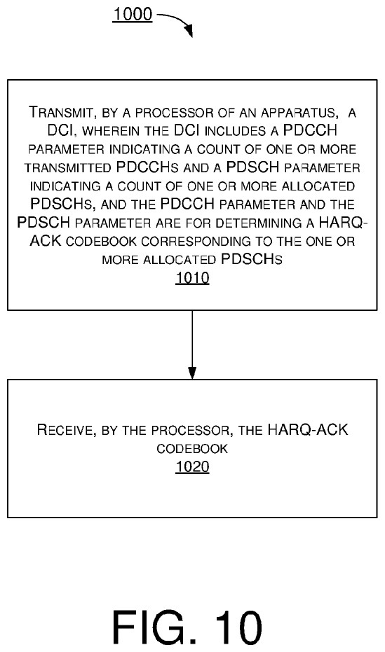

FIG. 10 illustrates an example process 1000 in accordance with an implementation of the present disclosure. Process 1000 may be an example implementation of above scenarios/schemes, whether partially or completely, with respect to Determining a HARQ-ACK codebook of the present disclosure. Process 1000 may represent an aspect of implementation of features of network apparatus 820. Process 1000 may include one or more operations, actions, or functions as illustrated by one or more of blocks 1010 to 1020. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 820 or any suitable network device or machine type devices. Solely for illustrative purposes and without limitation, process 1000 is described below in the context of network apparatus 820. Process 1000 may begin at block 1010.

At block 1010, process 1000 may involve processor 822 of network apparatus 820 transmitting a DCI. The DCI may include a PDCCH parameter indicating a count of one or more transmitted PDCCHs and a PDSCH parameter indicating a count of one or more allocated PDSCHs. The PDCCH parameter and the PDSCH parameter may be for determining a HARQ-ACK codebook corresponding to the one or more allocated PDSCHs. Process 1000 may proceed from block 1010 to block 1020.

At block 1020, process 1000 may involve processor 822 of network apparatus 820 receiving the HARQ-ACK codebook.

In some implementations, the HARQ-ACK codebook corresponding to the one or more allocated PDSCHs may be determined based on a number of the one or more missed PDCCHs and a number of the one or more missed PDSCHs. The number of one or more missed PDCCHs may be determined by comparing the count of the one or more transmitted PDCCHs with a count of one or more informed PDCCHs. The number of one or more missed PDSCHs may be determined by comparing the count of the one or more allocated PDSCHs with a count of one or more informed PDSCHs.

In some implementations, the DCI may schedule a first PDSCH. The first PDSCH and a second PDSCH scheduled by a previous DCI may be both associated with the same carrier index. The HARQ-ACK codebook may include a first HARQ-ACK corresponding to the first PDSCH and a second HARQ-ACK corresponding to the second PDSCH. The first HARQ-ACK may be prior to the second HARQ-ACK in the HARQ-ACK codebook.

In some implementations, the DCI may schedule a first PDSCH associated with a first carrier index and a second PDSCH associated with a second carrier index. The HARQ-ACK codebook may include a first HARQ-ACK corresponding to the first PDSCH and a second HARQ-ACK corresponding to the second PDSCH. The first HARQ-ACK may be prior to the second HARQ-ACK in the HARQ-ACK codebook in an event that the first carrier index is smaller than the second carrier index.

In some implementations, the DCI may schedule a first PDSCH and a second PDSCH both associated with the same carrier index. The HARQ-ACK codebook may include a first HARQ-ACK corresponding to the first PDSCH and a second HARQ-ACK corresponding to the second PDSCH. The first HARQ-ACK may be prior to the second HARQ-ACK in the HARQ-ACK codebook in an event that the second PDSCH is after the first PDSCH with respect to time domain.

In some implementations, process 1000 involve processor 822 of network apparatus 820 transmitting an indicator indicating a size of the HARQ-ACK codebook.

In some implementations, the HARQ-ACK codebook may be determined for one or more serving cells. The HARQ-ACK codebook may be received via an UL resource scheduled for the one or more serving cells.

In some implementations, the UL resource may include another HARQ-ACK codebook.

In some implementations, the DCI may include at least one field of: a HARQ or PDSCH group index; a feedback indicator; a data indicator; a redundancy version; and a HARQ process number. In an invent that the DCI includes single DCI, the at least one field may exist in a common part of DCI fields. In an event that the DCI includes two-stage DCI, the at least one field may exist in a first stage DCI or a common part of a second stage DCI.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink control information (DCI), wherein the DCI includes a physical downlink control channel (PDCCH) parameter indicating a count of one or more transmitted PDCCHs and a physical downlink shared channel (PDSCH) parameter indicating a count of one or more allocated PDSCHs;
determining, by the processor, a hybrid automatic repeat request-acknowledgment (HARQ-ACK) codebook corresponding to the one or more allocated PDSCHs according to the PDCCH parameter and the PDSCH parameter; and
transmitting, by the processor, the HARQ-ACK codebook.

2. The method of claim 1, wherein the step of determining the HARQ-ACK codebook corresponding to the one or more allocated PDSCHs according to the PDCCH parameter and the PDSCH parameter further comprises:
determining a number of one or more missed PDCCHs by comparing the count of the one or more transmitted PDCCHs with a count of one or more informed PDCCHs;
determining a number of one or more missed PDSCHs by comparing the count of the one or more allocated PDSCHs with a count of one or more informed PDSCHs; and
determining the HARQ-ACK codebook corresponding to the one or more allocated PDSCHs based on the number of the one or more missed PDCCHs and the number of the one or more missed PDSCHs.

3. The method of claim 1, wherein the DCI includes a single DCI or a two-stage DCI scheduling at least one PDSCH across one or more carriers or one or more slots.

4. The method of claim 1, wherein the DCI schedules a first PDSCH, the first PDSCH and a second PDSCH scheduled by a previous DCI are both associated with the same carrier index, the HARQ-ACK codebook includes a first HARQ-ACK corresponding to the first PDSCH and a second HARQ-ACK corresponding to the second PDSCH, and the first HARQ-ACK is prior to the second HARQ-ACK in the HARQ-ACK codebook.

5. The method of claim 1, wherein the DCI schedules a first PDSCH associated with a first carrier index and a second PDSCH associated with a second carrier index, the HARQ-ACK codebook includes a first HARQ-ACK corresponding to the first PDSCH and a second HARQ-ACK corresponding to the second PDSCH, and the first HARQ-ACK is prior to the second HARQ-ACK in the HARQ-ACK codebook in an event that the first carrier index is smaller than the second carrier index.

6. The method of claim 1, wherein the DCI schedules a first PDSCH and a second PDSCH both associated with the same carrier index, the HARQ-ACK codebook includes a first HARQ-ACK corresponding to the first PDSCH and a second HARQ-ACK corresponding to the second PDSCH, and the first HARQ-ACK is prior to the second HARQ-ACK in the HARQ-ACK codebook in an event that the second PDSCH is after the first PDSCH with respect to time domain.

7. The method of claim 1, further comprising:
receiving, by the processor, an indicator indicating a size of the HARQ-ACK codebook.

8. The method of claim 1, wherein the HARQ-ACK codebook is determined for one or more serving cells, and the HARQ-ACK codebook is transmitted via an uplink (UL) resource scheduled for the one or more serving cells.

9. The method of claim 8, wherein the UL resource includes another HARQ-ACK codebook.

10. The method of claim 1, wherein the DCI includes at least one field of:
a HARQ or PDSCH group index;
a feedback indicator;
a data indicator;
a redundancy version; and
a HARQ process number,
wherein in an event that the DCI includes single DCI, the at least one field exists in a common part of DCI fields,
wherein in an event that the DCI includes two-stage DCI, the at least one field exists in a first stage DCI or a common part of a second stage DCI.

11. A method, comprising:
transmitting, by a processor of an apparatus, a downlink control information (DCI), wherein the DCI includes a physical downlink control channel (PDCCH) parameter indicating a count of one or more transmitted PDCCHs and a physical downlink shared channel (PDSCH) parameter indicating a count of one or more allocated PDSCHs, and the PDCCH parameter and the PDSCH parameter are for determining a hybrid automatic repeat request-acknowledgment (HARQ-ACK) codebook corresponding to the one or more allocated PDSCHs; and
receiving, by the processor, the HARQ-ACK codebook.

12. The method of claim 11, wherein the HARQ-ACK codebook corresponding to the one or more allocated PDSCHs is determined based on a number of the one or more missed PDCCHs and a number of the one or more missed PDSCHs, the number of one or more missed PDCCHs is determined by comparing the count of the one or more transmitted PDCCHs with a count of one or more informed PDCCHs, and the number of one or more missed PDSCHs is determined by comparing the count of the one or more allocated PDSCHs with a count of one or more informed PDSCHs.

13. The method of claim 11, wherein the DCI schedules a first PDSCH, the first PDSCH and a second PDSCH scheduled by a previous DCI are both associated with the same carrier index, the HARQ-ACK codebook includes a first HARQ-ACK corresponding to the first PDSCH and a second HARQ-ACK corresponding to the second PDSCH, and the first HARQ-ACK is prior to the second HARQ-ACK in the HARQ-ACK codebook.

14. The method of claim 11, wherein the DCI schedules a first PDSCH associated with a first carrier index and a second PDSCH associated with a second carrier index, the HARQ-ACK codebook includes a first HARQ-ACK corresponding to the first PDSCH and a second HARQ-ACK corresponding to the second PDSCH, and the first HARQ-ACK is prior to the second HARQ-ACK in the HARQ-ACK codebook in an event that the first carrier index is smaller than the second carrier index.

15. The method of claim 11, wherein the DCI schedules a first PDSCH and a second PDSCH both associated with the same carrier index, the HARQ-ACK codebook includes a first HARQ-ACK corresponding to the first PDSCH and a second HARQ-ACK corresponding to the second PDSCH, and the first HARQ-ACK is prior to the second HARQ-ACK in the HARQ-ACK codebook in an event that the second PDSCH is after the first PDSCH with respect to time domain.

16. The method of claim 11, further comprising:
transmitting, by the processor, an indicator indicating a size of the HARQ-ACK codebook.

17. The method of claim 11, wherein the HARQ-ACK codebook is determined for one or more serving cells, and the HARQ-ACK codebook is received via an uplink (UL) resource scheduled for the one or more serving cells.

18. The method of claim 17, wherein the UL resource includes another HARQ-ACK codebook.

19. The method of claim 11, wherein the DCI includes at least one field of:
a HARQ or PDSCH group index;
a feedback indicator;
a data indicator;
a redundancy version; and
a HARQ process number,
wherein in an invent the DCI includes single DCI, the at least one field exists in a common part of DCI fields,
wherein in an event the DCI includes two-stage DCI, the at least one field exists in a first stage DCI or a common part of a second stage DCI.

20. An apparatus, comprising:
a transceiver which, during operation, wirelessly communicates with a wireless network; and
a processor communicatively coupled to the transceiver such that, during operation, the processor performs operations comprising:
receiving, via the transceiver, a downlink control information (DCI), wherein the DCI includes a physical downlink control channel (PDCCH) parameter indicating a count of one or more transmitted PDCCHs and a physical downlink shared channel (PDSCH) parameter indicating a count of one or more allocated PDSCHs;
determining a hybrid automatic repeat request-acknowledgment (HARQ-ACK) codebook corresponding to the one or more allocated PDSCHs according to the PDCCH parameter and the PDSCH parameter; and
transmitting, via the transceiver, the HARQ-ACK codebook.
